(19) United States
(12) Patent Application Publication
(10) Pub. No.: US 2002/0035561 A1
(43) Pub. Date: Mar. 21, 2002

(54) Method and system for database query

(76) Inventors: John Archer, Stony Brook, NY (US); Stephen Miklos, Norwalk, CT (US)

Correspondence Address: George T. Marcou, Kilpatrick Stockton LLP, Suite 800, 700 Thirteenth St., NW, Washington, DC, 20005, US

(21) Appl. No.: 09/734,693

(22) Filed: Dec. 13, 2000

Related U.S. Application Data
(60) Provisional application No. 60/170,528, filed on Dec. 14, 1999.

(51) Int. Cl. G06F 7/00

(52) U.S. Cl. 707/6; 705/35

(57) ABSTRACT

A method and system is disclosed for searching a database resident list or set of lists for user-defined text patterns, identifying a match, reporting information related to the search result, and maintaining the lists to be searched in a mutually updating distributed database with automatic failover. One embodiment of the present invention provides a method of using a computer utility program to maintain a database of sanctioned entities in a plurality of sanction lists where such sanction lists arise, for example, from OFAC, foreign governments, or internally. The computer utility program allows an authorized user to search user-selected text patterns against the sanction lists to identify a sanctioned entity. Further, the computer utility program is network based so that sanction lists may be searched using different hardware configurations worldwide. In addition, because the database is distributed and mutually updating, sanction lists may be dynamically updated globally and are completely redundant.

### CROSS-REFERENCE TO RELATED APPLICATIONS

This application claims priority to, and herein incorporates by reference, applicants' copending U.S. Provisional Application No. 60/170,528 filed Dec. 14, 1999.

### FIELD OF THE INVENTION

The present invention relates generally to a method of using a computer to query a database. More specifically, the invention relates to a system and method of network-based phrase searching by text pattern matching a desired phrase to a plurality of distributed, mutually updating database-resident lists in a platform independent manner.

### BACKGROUND OF THE INVENTION

The United States government historically has imposed various economic sanctions against hostile entities and their agents to further United States foreign policy and national security objectives. Such sanctions may include trade embargoes, blocked asset controls, and other restrictions on commercial and financial transactions. The success of these sanctions depends on the ability of commercial and financial institutions to detect and “block” or interdict transactions involving sanctioned entities before the transaction is executed. In many cases, sanctions imposed by the United States have been multilateralized by international treaty or agreement against, for example, individuals, corporations, countries, or groups that are subject to sanctions, to give effect to sanctions worldwide.

In the United States, the Department of the Treasury Office of Foreign Assets Control (OFAC) administers laws and regulations implanting economic sanctions. OFAC regulations are intended to ensure that sanctioned entities do not derive any benefits from assets held within the United States or held elsewhere by United States-based institutions. Commercial and financial institutions subject to OFAC regulations, such as banks, securities firms, or insurance companies, are obligated by law to interdict sanctioned transactions and report such interdiction to OFAC. Severe civil or criminal penalties can be imposed for breaching OFAC rules. Consequently, there is a need for commercial and financial institutions to screen transactions or accounts for the identities of sanctioned businesses, countries, organizations or individuals against those sanctioned by OFAC and interdict such transactions before they are executed.

In the banking industry, for example, the detection of OFAC sanctioned transactions or assets gives rise to certain banking requirements. For example, when a bank confirms that it possesses accounts or assets belonging to a sanctioned entity, or detects a transaction going to, coming from, or related to a sanctioned destination, the funds must be interdicted. Blocked funds must be placed on a post no debit status where all credits are posted and blocked, and must start bearing interest. Blocked accounts can not be debited unless permission is received from OFAC, but credits can and must be made. Banks are prohibited from returning the funds to the remitter without permission from OFAC.

In addition to economic sanctions imposed by OFAC, other agencies of the United States, such as, for example the Internal Revenue Service or Drug Enforcement Administration, may impose varying degrees of monitoring or control over financial or commercial transactions. In addition to sanctions arising within the United States, foreign governments may also impose economic sanctions. Banks and commercial institutions may additionally have internal risk control procedures that require certain transactions to be interdicted, for example, where certain individuals, groups or organizations owe money to the institution or have a history of suspicious activity. Thus, “sanction lists,” enumerating the individuals, organizations, entities or countries subject to economic sanctions may arise from a plurality of sources, domestic, foreign or internal. Further, such sanction lists are subject to continual change as entities are added to or dropped from the list.

Large banks or commercial institutions that conduct business worldwide are particularly affected by the existence of a plurality of sanction lists. The large volume of transactions conducted on a daily basis makes it impractical and inefficient to manually check each transaction against a plurality of sanction lists. Moreover, because of the dynamic character of sanction lists, maintaining a current sanction list in all locations where business is conducted worldwide is problematic. In addition, because banks and large institutions operating worldwide typically employ a variety of computer platforms in different locations, a computer sanction list searching utility program that is designed to operate on a single computer platform would not be useful.

Further, entities appearing on a sanction list may be identified as a text phrase that may be a phrase in the English language or be a text phrase that is an English translation of a foreign phrase, such as BANQUE X, for example. Moreover, text phrases describing a sanctioned individual or other entity may be arranged in a number of mutations, including for example: John Q. Public; J. Q. Public; Public, J. Q. In addition, phrases describing sanctioned entities may be intentionally disguised or corrupted by rearranging the components of the text phrase, including for example, incorrect letters, missing letters, extraneous letters, or transposed letters. Text phrases describing sanctioned individuals or entities may further include indirect descriptions, such as President of Country X.

It is noted that others have attempted to address some of the above described situations. In general, the proposed solutions are generally limited to screening transactions against the U.S. Treasury OFAC list and do not address the complications that arise with global sanction lists derived from other sources. Further, many of the proposed solutions are PC-based and not compatible with an internet environment.

It is known that FircoSoft has advertised an OFAC transaction screening software referred to as “OFAC Agent.” According to FircoSoft, this product is based on an algorithm that may be user-configured to search a file-resident OFAC database according to word-level matching, string-level matching or both, with varying degrees of precision. Although the FircoSoft product is intended to be compatible with different hardware platforms, dependency on the OFAC list limits its global applications.

Accordingly, there is a need for a general purpose computer utility program to maintain a database of sanctioned entities as a plurality of “sanction lists” where such sanction lists may arise from the United States government, foreign governments, or internal business security reasons, and allow a user to search those lists. There is a further need for a computer utility program that is capable of searching a sanction list or user defined set of sanction lists in an efficient manner to allow determination of whether any of the parties or assets involved in a transaction are sanctioned before the transaction is executed. There is an additional need for a list searching utility program that is capable of searching sanctioned entities on a list by matching text patterns in a phrase, including mutations of phrasal text patterns and indirect descriptors of the sanctioned entity.

There is an additional need for a flexible search utility program that can be customized to search user designated sanction lists that may arise from a plurality of sources worldwide. There is a further need for an adaptable utility program that allows sanction lists to be updated as sanctioned entities are added or withdrawn. There is a further need for a network-based, platform independent list search utility program that will run on different vendor or hardware systems and be accessible to approved users worldwide. There is an additional need for a search utility program that maintains a distributed database of redundant sanction lists such that the databases are mutually updating and provide automatic failover to a redundant database in the event of a system failure.

### SUMMARY OF THE INVENTION

Embodiments of the invention can meet these needs, and others, through a system and method for monitoring transactions to detect and identify matches between parties to the transaction and entities identified on a sanction list or set of sanction lists.

In some embodiments of the invention, it is possible to search a user defined text phrase against sanction lists or a set of sanction lists by phrasal matching of text patterns in an efficient manner.

In some embodiments of the present invention, a method for a user to initiate a search that compares the search object to a list or set of lists can be performed.

In some further embodiments of the present invention, a flexible list searching system that is capable of accommodating changes in the database of lists to be searched can be provided.

In some further embodiments of the present invention, a network based generic pattern matching utility program that is accessible by a plurality of users can be provided.

In some further embodiments of the present invention, enhanced system redundancy through a distributed database of sanction lists that are mutually updating can be provided.

In some further embodiments of the present invention, automatic failover to a replicate database in the event of a server failure can be provided.

In some further embodiments of the present invention, a generic, platform independent list searching system that is capable of interfacing with many different computer systems can be provided.

The present invention can include a network based system and method for searching database resident lists, particularly for searching a user defined list or set of lists for text patterns that occur within the list in an efficient manner, identifying a match, reporting information related to the search result, and maintaining the lists to be searched in a mutually updating distributed database with automatic failover.

Additional objects, advantages and novel features of various embodiments of the invention will be set forth in part in the description that follows, and in part will become more apparent to those skilled in the art upon examination of the following or upon learning by practice of the invention.

### BRIEF DESCRIPTION OF THE DRAWINGS

In the Figures:

FIG. 1 is a diagram of a network system implementing an embodiment of the present invention.

FIG. 2 is a diagram showing additional features of the logical components of an embodiment of the present invention in a network.

FIG. 3 is a diagram showing the text pattern matching feature of an embodiment of the present invention.

### DETAILED DESCRIPTION OF THE PREFERRED EMBODIMENTS

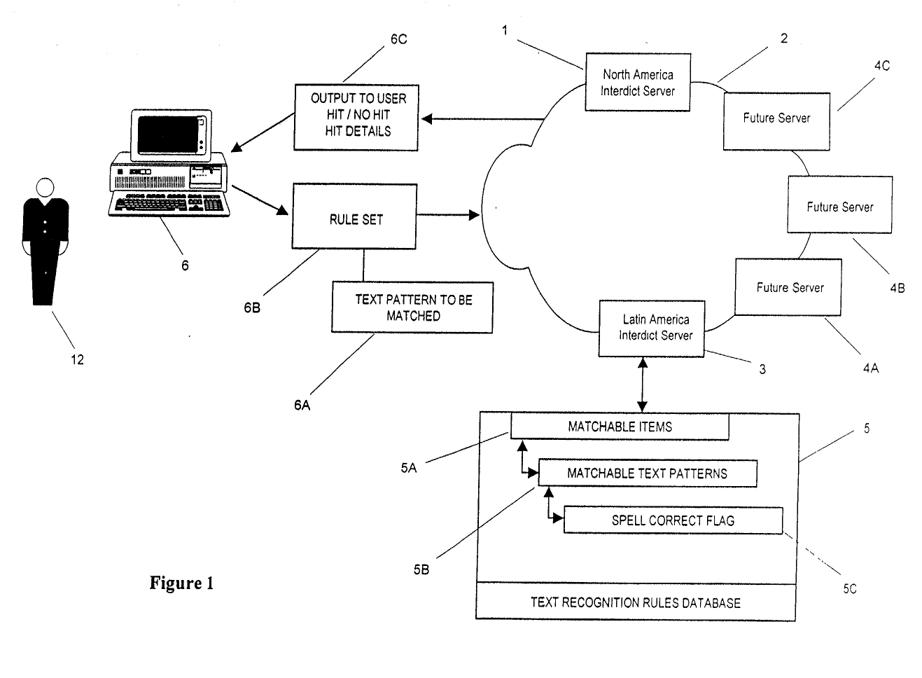

As shown in FIG. 1, the North American Global Interdict server 1 is coupled to a plurality of Global Interdict™ servers 3 and 4A-C via a network 2. Each server 1, 3, 4A-C is an independent logical entity. A user 12, uses computer 6 equipped with Graphical User Interface (GUI) software to invoke Global Interdict servers 1, 3, 4A-C via network 2. The Global Interdict system is platform independent and can service user applications running in environments such as UNIXT™, Windows NT™, IBM™, and VAX™ computer platforms.

Each Global Interdict Server 1, 3, 4A-C includes a Text Recognition Rules database 5, which FIG. 1 shows in conjunction with Latin American Interdict Server 3 for convenience only. The Text Recognition Rules database 5 includes Matchable Items 5A which includes sanctioned entities or concepts, in a plurality of categories, such as names, countries, individuals, companies or vessels. Matchable Text Patterns 5B may include one or more regular expression operators, such as letters, digits, spaces, synonyms or abbreviations to further define Matchable Items 5A. A Spell Correct Flag 5C indicates whether spell correction is to be applied to a search request while executing a comparison to Matchable Text Patterns 5B.

Further descriptive and explanatory information associated with Matchable Items 5A may also be included in the Text Recognition Rules database 5. While Text Recognition Rules database 5 includes a list of sanctioned entities arising from a source such as OFAC, a plurality of Text Recognition Rules databases 5 may be included in each Global Interdict Server 1, 3, 4A-C, with each database including a separate list of sanctioned entities of different origin.

In FIG. 1, a user 12 invokes Latin America Global Interdict Server 3 functions through remote calls across network 2, by, for example, computer 6. Once the Latin America Global Interdict Server 3 authenticates user 12, the user 12 requests one or more user defined text strings 6A to be matched against one or more Text Recognition Rules database(s) 5. Text Recognition Rules database(s) 5 selected by user 12 via computer 6 for verification against text 6A are specified by user 12 in a Rule Set 6B. Alternatively, a verification request to a Global Interdict Server 1, 3, 4A-C may be invoked by a computer program or data file (not shown) providing the text strings 6A and Rule Set 6B to be verified.

On receiving a request from user 12 via computer 6 over network 2, the Latin America Global Interdict Server 3 scans the input text pattern 6A to be matched against the Text Recognition Rules database(s) 5 specified according to the user defined Rule Set 6B. Each Text Recognition Rules database 5 includes individual phrases that identify Matchable Text Patterns 5B as list of sanctioned entities in that database, arrayed in a letter tree such that a stepwise search at any given point within the database may be executed rapidly and efficiently. In addition, setting Spell Correct Flag 5C provides spelling variations of Matchable Text Patterns 5B to be implemented by backtracking within the letter tree.

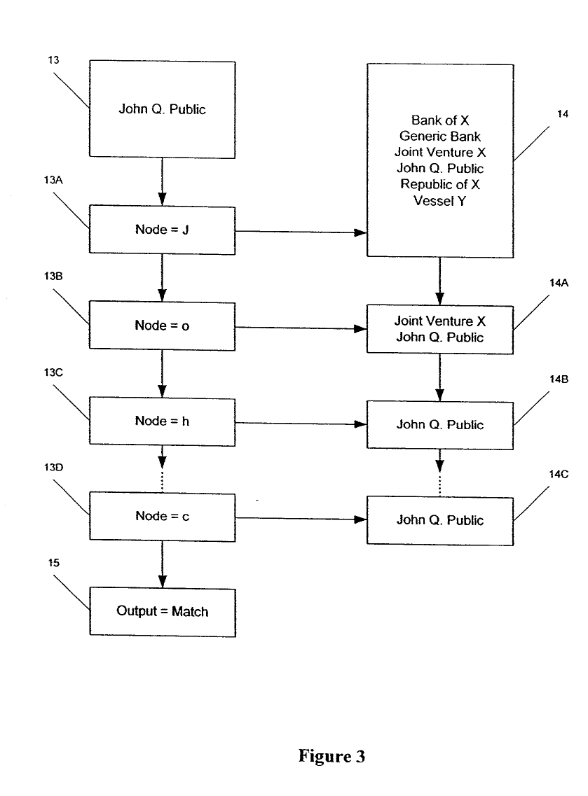

FIG. 3 provides a more detailed description of phrasal text pattern matching used by an embodiment of the invention. In FIG. 3, a text pattern to be matched 13, which includes the text pattern John Q. Public, is evaluated against a Matchable Text Pattern database 14, which includes a plurality of text patterns arrayed in a letter tree. For each character in the text pattern to be matched 13, a search node 13A-D is generated. Search nodes 13A-D are compared against characters and positions in the letter tree in Matchable Text Pattern database 14 to derive an output 15 confirming an exact match. In an embodiment of the invention shown in FIG. 3, letter case, punctuation, and white space may be considered in executing a search, and an exact phrasal match is shown; other embodiments of the invention may include spell correction, missing, erroneous, or transposed characters in evaluating a text pattern against a Matchable Text Pattern database.

In FIG. 1, Latin America Global Interdict server 3 delivers a response 6C to user 12 via computer 6 over network 2. Output 6C includes whether a match (hit) occurred between user submitted text pattern 6A and interdict list(s) maintained in Text Recognition Rules database(s) 5. For each phrasal match detected, the Latin America Global Interdict server 3 returns an output 6C to user 12 via computer 6 over network 2, the output 6C includes such information as, for example, the starting position of the match in the text string submitted; the number of characters matched; the text pattern matched; the source of the sanction imposed; and other information available in the Text Recognition Rules database 5. Output 6C may be a variety of forms, including GUI, printout, or other data forms suitable for electronic transmittal, storage and retrieval. In addition, records of matches may be stored electronically in hit logs including details of the match and be used to generate reports as required, for example, by government authorities under OFAC.

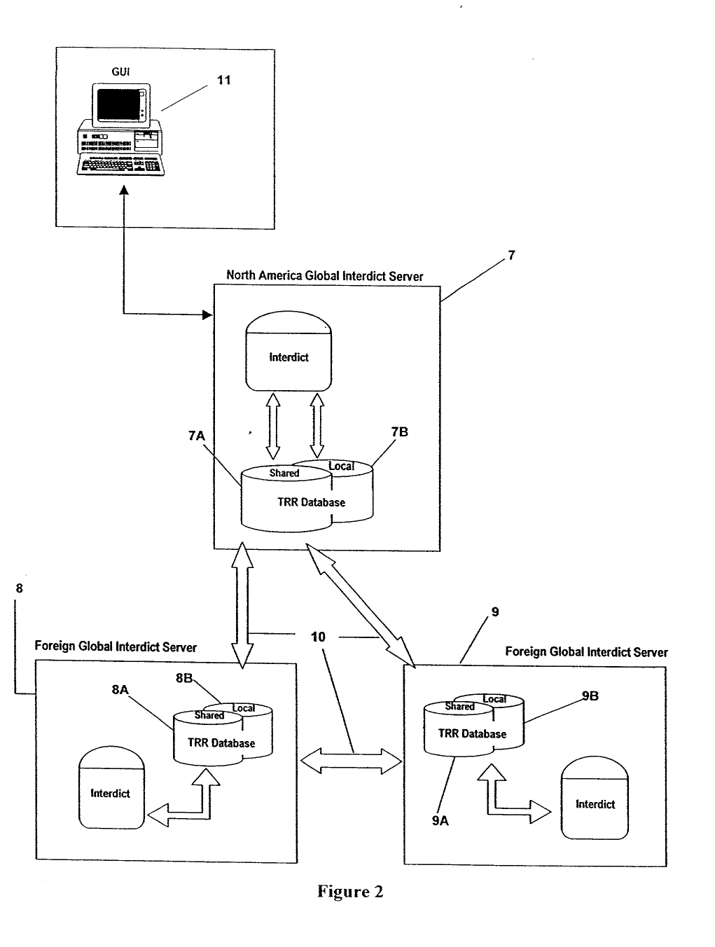

FIG. 2 shows additional features of the logical components of an embodiment of the present invention. In FIG. 2, North America Global Interdict server 7 is connected to Foreign Global Interdict servers 8, 9 via global network 10. Each Global Interdict server, 7, 8, 9 includes shared Text Recognition Rules databases 7A, 8A, 9A and Local Text Recognition Rules databases 7B, 8B, 9B. Shared Text Recognition Rules databases 7A, 8A, 9A are required globally and have the same Text Recognition Rules. Text Recognition Rules for local applications are stored in Local Text Recognition Rules databases 7B, 8B, 9B. The databases resident in Global Interdict servers 7, 8, 9 are mutually replicated over the global network 10, and thus provides a high level of database redundancy, with the database included in each Global Interdict server 7, 8, 9 being a back up for each other. Further, modifications to any Global Interdict server database are automatically replicated in all other databases. For example, a privileged user accessing the shared Text Recognition Rules database 7A in North American server 7 via computer 11 for database maintenance, such as addition, modification, or deletion of matchable text items, would automatically effect identical changes to shared databases in Foreign Servers 8, 9. In addition, automatic failover routs a calling application to an alternate database replicated on a Global Interdict server in the event of a server failure. Other features include data security and encryption, maintaining an audit trail to keep track of changes made to system databases, exceptions logging and report generation.

While preferred embodiments have been described herein, it will be understood that the present invention incorporates any modifications, variations, adaptations and the like as would be apparent to those skilled in the art based on this disclosure.

We claim:

1. A method of searching financial transactions against a server-resident file of sanctioned entities using a network, the network including a plurality of servers accessible by a plurality of user terminals, comprising:
inputting at one of the plurality of user terminals a search request text pattern for searching a server-resident database of sanctioned entities, the search request text pattern including a text string, the text string further including one or more regular expression operators, including letters, digits or punctuation marks to further define the search request text pattern and to further identify the server being invoked;
storing the search request text pattern as an entry in a search request instruction file, the search request instruction file being accessible by a server processor;
transmitting the search request instruction file to the server processor invoked via the network;
the server processor checking the search request text pattern, the checking including matching text patterns of the search request text pattern against a file of sanctioned entities stored as a matchable text pattern file in the server; and
upon execution of the search, transmitting search results to the user terminal via the network.

2. The method according to claim 1, wherein the server-resident matchable text pattern file includes the OFAC sanction list.

3. The method according to claim 2, wherein servers are located in different countries.

4. The method according to claim 3, wherein the server includes a plurality of matchable text pattern files including user defined sanction lists.

5. The method according to claim 4, wherein the search request instruction file further defines the matchable text pattern files to be searched.

6. The method according to claim 1, further comprising:
defining sanctioned entities as matchable text patterns;
storing matchable text patterns as individual phrases;
arranging individual phrases as a letter tree array;
generating a search node for each character in the search request text pattern to be checked against matchable text patterns;
comparing search nodes against characters and positions in the letter tree array; and
determining whether a match occurs.

7. The method according to claim 6, wherein the search request instruction file includes a spell correct flag to include spelling variations of the search request text pattern to be checked against the matchable text pattern file.

8. The method according to claim 6, wherein the search request instruction file includes a missing letters flag to include missing letters in the text pattern to be checked against the matchable text pattern file.

9. The method according to claim 6, wherein the search request instruction file includes a transposed letters flag to include transposed letters in the text pattern to be checked against the matchable text pattern file.

10. The method according to claim 1, further comprising:
generating a user authorization code at the time the terminal user inputs a text pattern selection for checking against a sanctioned entity database;
storing the authorization code with the text pattern selection in the search request instruction file, wherein the authorization code must be received in order to access the server.

11. The method according to claim 1, further comprising:
generating a privileged user authorization code, wherein the privileged user authorization code must be received in order to create or modify a matchable text pattern file.

12. The method according to claim 1, wherein matchable text pattern files are replicated between each server via the network.

13. The method according to claim 12, wherein matchable text pattern files are mutually updating via the network.

14. The method according to claim 13, wherein server failure automatically routes search request instruction files to an alternate server.

15. The method according to claim 1, wherein the search request instruction file is generated by a computer program.

16. A transaction screening system including a text phrase defining the parties to the transaction and a network, the network including a plurality of servers and user terminals, comprising:
means for inputting at one from the plurality of user terminals a selection of text patterns for searching a server-resident database of sanctioned entities, wherein text pattern selections include a text string including one or more regular expression operators, including letters, digits or punctuation marks to further define the text pattern selection and identify the server being invoked;
means for storing the text pattern selection as an entry in a search request instruction file, the search request instruction file being accessible by a server processor;
means for transmitting the search request instruction file to the server processor invoked via the network;
means for the server processor checking the search request text pattern, the means for checking including matching text patterns of the search request instruction file against a list of sanctioned entities stored as a matchable text pattern file in the server; and
means for transmitting search results to the user terminal via the network upon execution of the search.

17. The system according to claim 16, wherein the server resident matchable text pattern file includes the OFAC sanction list.

18. The system according to claim 17, wherein servers are located in different countries.

19. The system according to claim 18, wherein the server includes a plurality of matchable text pattern files including user defined sanction lists.

20. The system according to claim 19, wherein the search request instruction file further defines the matchable text pattern files to be searched.

21. The system according to claim 16, further including:
means for defining sanctioned entities as matchable text patterns;
means for storing matchable text patterns as individual phrases;
means for arranging individual phrases as a letter tree array;
means for generating a search node for each character in the search request text pattern to be checked against matchable text patterns;
means for comparing search nodes against characters and positions in the letter tree array; and
means for determining whether a match occurs.

22. The system according to claim 21, wherein the search request instruction file includes a means for including spelling variations of search request text patterns to be checked against the matchable text pattern file.

23. The system according to claim 21, wherein the search request instruction file includes a means for including missing letters in the search request text pattern to be checked against the matchable text pattern file.

24. The system according to claim 21, wherein the search request instruction file includes a means for including transposed letters in the search request text pattern to be checked against the matchable text pattern file.

25. The system according to claim 16, further comprising:
means for generating a user authorization code at the time the terminal user inputs a text pattern selection for checking against a sanctioned entity database; and
means for storing the authorization code with the text pattern selection in the search request instruction file, wherein the authorization code must be received in order to access the server.

26. The system according to claim 16, further comprising:
means for generating a privileged user authorization code, wherein the privileged user authorization code must be received in order to create or modify a matchable text pattern file.

27. The system according to claim 16, including means for replicating matching text pattern files between each server via the network.

28. The system according to claim 27, including means for mutually updating matchable text pattern files via the network.

29. The system according to claim 28, including means for automatically routing search request instruction files to an alternate server upon server failure.

30. The system according to claim 16, including means for generating search request instruction file by a computer program.
